(19) United States
(12) Patent Application Publication
(10) Pub. No.: US 2025/0011620 A1
(43) Pub. Date: Jan. 9, 2025

(54) COMPOSITION FOR AN ADDITIVE MANUFACTURING PROCESS

(71) Applicant: EOS GMBH ELECTRO OPTICAL SYSTEMS, Krailling (DE)

(72) Inventors: Sybille Fischer, Eichenau (DE); Andreas Pfister, Fürth (DE); Karl Freihart, Germering (DE); Jens Sesseg, Germering (DE); Laura Unger, Erlangen (DE); Jochen Schmidt, Schwarzenbach am Wald (DE); Amdreas Bück, Gommern (DE); Maximilian Dechet, Zirndorf (DE)

(21) Appl. No.: 18/694,681

(22) PCT Filed: Sep. 30, 2022
(86) PCT No.: PCT/EP2022/077317

§ 371 Date: Mar. 22, 2024

(30) Foreign Application Priority Data
Oct. 8, 2021 (DE) 10 2021 126 217.8

(51) Int. Cl. C09D 179/08; B29B 9/12; B29C 64/153; B29C 64/314; B29K 79/00; B33Y 10/00; B33Y 40/10; B33Y 70/00; C08J 3/09; C08J 3/11; C08J 3/14; C09D 5/03

(52) U.S. Cl. CPC C09D 179/08; B29B 9/12; B29C 64/153; B29C 64/314; B33Y 10/00; B33Y 40/10; B33Y 70/00; C08J 3/095; C08J 3/11; C08J 3/14; C09D 5/03; B29K 2079/085; B29K 2995/004; B29K 2995/0063; B29K 2995/0077; B29K 2995/0094; B29K 2995/0096; C08J 2379/08

(57) ABSTRACT

The present invention concerns a composition comprising at least one polymer, wherein the polymer solidifies from a molten material in a substantially amorphous or completely amorphous form. The present invention further concerns a process for the production of the composition in accordance with the invention, as well as a structural component comprising a composition in accordance with the invention and the use of the composition in accordance with the invention.

The present invention relates to a composition comprising at least one polymer, wherein the polymer solidifies from a molten material in a substantially amorphous or completely amorphous form. Furthermore, the present invention relates to a process for the production of the composition in accordance with the invention as well as to a structural component comprising a composition in accordance with the invention and to the use of the composition in accordance with the invention.

Additive manufacturing processes for the production of prototypes and the industrial manufacture of structural components which operate on the basis of powdered substances enable sculptural articles to be produced and are becoming more and more important. In the manufacturing processes, the desired structures are manufactured layer by layer by selective melting and consolidation or by the application of a binder and/or adhesive. The process is also known as “additive manufacturing” “digital fabrication” or “three-dimensional (3D) printing”.

For decades, processes for the production of prototypes have been used in industrial development processes (rapid prototyping). Because of technological advances in systems, however, parts are now being made which meet the quality demands for a finished product (rapid manufacturing).

In practice, the term “additive manufacturing” is also replaced by “generative manufacturing” or “rapid technology”. Examples of additive manufacturing processes which use a powdered substance are sintering, melting or bonding using binders.

Polymer systems are often used as the powdered substances for the production of shaped articles. Industrial users of such systems demand good processability, high dimensional tolerance and good mechanical properties from the shaped articles which are produced.

During the production of 3D structural components, it is extremely important to obtain binding of the layers in the molten material with the layers of the structural component lying below it, because it is only in the molten material that interdiffusion can take place between the layers. If the layers do not bind sufficiently, in the finished state, 3D structural components have a tendency to delaminate and lose strength.

During the production of 3D structural components using additive manufacturing (AM), in particular by means of powder bed-based AM processes in which the powder is selectively solidified by the application of radiant energy, then on the one hand, the construction space temperature must be above the crystallization temperature of the respective polymer, and on the other hand, the temperature necessarily has to be below the melting temperature, because otherwise, the powder cake would melt in the construction space. In the context of powder bed-based additive manufacture, a polymer powder is therefore usually heated to just below the melting temperature before the remaining energy required to melt the powder and obtain a sufficiently low melt viscosity is introduced by means of a source of radiation. The temperature range between the crystallization temperature (TK) and the melt temperature (TM) is known as the process window or the sintering window for the polymer. If crystallization and melting of a polymer overlap to a substantial extent on the temperature axis, then it is highly probable that that polymer could not be used in the process, i.e. the process window would not be sufficient.

Thus, it would be advantageous for a polymer to have a melting temperature which was as high as possible with respect to the crystallization temperature or the glass transition temperature in order, therefore, to widen the process window or the sintering window.

Thus, an objective of the present invention is to provide an improved composition which is preferably suitable for additive manufacturing processes as a substance which can be reliably processed for the production of shaped articles, which has mechanical stability and has high dimensional tolerance. In particular, an objective of the present invention is to provide an improved composition which has a larger process window, in particular a higher melting temperature.

In accordance with the invention, this objective is achieved by means of a composition as claimed in claim 1. Furthermore, this objective is achieved by means of a process for the production of the composition as claimed in claim 9, by a process for the production of a structural component as claimed in claim 14, as well as by a use of the composition in accordance with the invention as claimed in claim 18.

Thus, the present invention concerns a composition, in particular as a construction material for additive manufacturing as mentioned above, comprising at least one polymer, wherein the polymer is in the form of polymer particles and wherein the polymer is selected from at least one thermoplastic polymer,
wherein the at least one thermoplastic polymer solidifies from a molten material in at least a substantially amorphous or completely amorphous form and is producible as such,
in that a melting temperature of the polymer is at least 280° C., preferably at least 290° C., preferentially at least 300° C., and/or wherein a melting temperature of the material is up to 400° C., preferably up to 375° C., particularly preferably up to 350° C., and/or
in that a specific melting enthalpy of the polymer is at least 28 J/g, preferably at least J/g, preferentially at least 35 J/g, and/or wherein a specific melting enthalpy of the material is up to 150 J/g, preferably up to 125 J/g, preferentially up to 100 J/g.

In its simplest embodiment, a composition in accordance with the invention comprises at least one thermoplastic polymer, wherein the thermoplastic polymer solidifies from a molten material in a substantially amorphous or completely amorphous form. The determination of such a thermoplastic polymer is known to the person skilled in the art and may, for example, be carried out using differential scanning calorimetry (DSC).

In particular, a polymer is assumed to “solidify in a substantially amorphous or completely amorphous form” when it has a specific melting enthalpy in the second heating cycle of <1 J/g at a heating rate of 20 K/min and a cooling rate of 5 K/min, measured using DSC in accordance with DIN EN ISO 11357-1 (3:2018-07).

Preferably, the composition in accordance with the invention is in the form of a powder.

Surprisingly, the melting temperature of a material obtained in this manner is at least 280° C., preferably at least 290° C., preferentially at least 300° C. However, at the most, the melting temperature of the material is up to 400° C., preferably up to 375° C., particularly preferably up to 350° C. Advantageously, such a high melting temperature of the composition can broaden the process window.

The designation “melting temperature” here should be understood to mean the temperature at which a material melts, i.e. is transformed from the solid into the liquid physical state. In the present case, the terms “melting temperature” and “melting point” are used synonymously. In the case in which a composition has a plurality of melting peaks, the melting temperature should be understood to mean the peak temperature of the most prominent peak. Methods for determining the melting temperature are known to the person skilled in the art and can usually be measured with the aid of differential scanning calorimetry (DSC) in accordance with DIN EN ISO 11357 (3-2018-07).

In accordance with the invention, a high melting temperature enables heating to higher temperatures and therefore a lower input of energy by the source of radiation, which significantly reduces the probability of degradation of the polymer during the irradiation.

The viscosity which is reduced by melting is therefore advantageous to good fluidification of the melt, whereupon denser structural components with fewer pores and improved mechanical properties and a higher structural component density can be obtained. Furthermore, the high melting temperature means that less energy has to be applied using the laser in order to heat the polymer to a sufficiently low viscosity at which good fluidification of the melt, and therefore good binding of the layers, is made possible.

Furthermore, the composition in accordance with the invention has a specific melting enthalpy of the material of at least 28 J/g, preferably at least 30 J/g, more preferably at least J/g. At most, the specific melting enthalpy of the composition is up to 150 J/g, preferably up to 125 J/g, preferentially up to 100 J/g. An advantageous composition of this type enables better delimitation of the structural component from non-sintered powder because in this manner, fewer powder particles adjacent to the structural component are melted with it. Furthermore, by means of an advantageous melting enthalpy of this type, a higher construction temperature and therefore a broader process window is produced.

The designation “melting enthalpy” or “specific melting enthalpy” should be understood to mean the quantity of energy which is required in order to melt a sample of material at its melting temperature under constant pressure (isobaric), i.e. for transfer from the solid to the liquid physical state. Methods for determining the melting enthalpy are known to the person skilled in the art; thus, the measurement of the melting enthalpy may, for example, be carried out by DSC in accordance with DIN EN ISO 11357 (3:2018-07).

In the context of the invention, the melting point Tm and the specific melting enthalpy or crystallization enthalpy ΔH of the materials used are determined by means of DSC measurements in accordance with the standard DIN EN ISO 11357 (3-2018-07). The melting point here corresponds to the peak temperature of the melting peak in the DSC curves. In this regard, the measurements were carried out on a “Mettler Toledo DSC823e” type DSC instrument with an automatic sample changer. The analyses were carried out with “STARe Software”, Version 16.30. The flushing gas was nitrogen 5.0, i.e. nitrogen with a purity of 99.999 percent by volume. A sufficiently broad temperature range was examined for each material (as an example, for the PEI material being examined, the range was 0° C. to 400° C.). The heating rate or cooling rate was 20 K/min in each case with a holding time of 5 min before each heating or cooling cycle.

Furthermore, the composition in accordance with the invention ensures that the structure of the powder is homogeneous, so that in this way, an improved flowability or pourability, and therefore in the context of additive manufacturing processes, a uniform powder input, is made possible. A bulk material is then considered to have good flowability if the bulk material can easily be caused to flow. Methods for determining the flowability or pourability are known to the person skilled in the art. In addition to other parameters, the flowability or pourability of the powder may, for example, be determined with the aid of the flow factor (ff_{c}) and unconfined yield strength (UYS) (in accordance with ASTM D6773-16).

Preferably, the at least one thermoplastic polymer which solidifies from a molten material at least in a substantially amorphous or completely amorphous form can be obtained by precipitation from a first medium or a mixture of a first and at least one further medium. In the present case, the terms “can be obtained”, “can be presented” and “can be produced” are used synonymously.

Preferably, such a first and/or further medium is selected from at least one organic medium, preferably from an organic, moderate solvent for the at least one polymer. The designation “moderate solvent” as used here should be understood to mean a non-solvent for the polymer for which at room temperature the polymer does not dissolve in it or only dissolves to a small extent so that the dissolved proportion of the polymer is less than 5% by weight. At temperatures above room temperature, however, it acts as a solvent so that at least 5% of the polymer is present in the dissolved form. The terms “moderate solvent” and “solvent” will be used synonymously below.

The term “polymer” or a “polymer system” or “polymer material” as used in the present application should be understood to mean at least one homopolymer and/or heteropolymer which is constructed from a plurality of monomers. While homopolymers are covalent concatenations of identical monomers, heteropolymers (also known as copolymers) are constructed out of covalent concatenations of different monomers. In this regard, a polymer system in accordance with the present invention may comprise both a blend of the aforementioned homopolymers/and/or heteropolymers as well as more than one polymer system.

The terms “polymer”, “polymer system” and “polymer material” will be used synonymously below.

In the context of the present invention, heteropolymers may therefore be selected from random copolymers, in which the distribution of the two monomers in the chain is random, from gradient copolymers, which in principle are similar to random copolymers, but in which the proportion of one monomer increases through the chain and that of the other decreases, of alternating copolymers, in which the monomers alternate, of block copolymers or segment copolymers, which consist of longer sequences or blocks of each monomer, and of graft copolymers, in which blocks of one monomer are grafted onto the scaffold (backbone) of another monomer.

The composition in accordance with the invention may advantageously be used for additive manufacturing processes. Additive manufacturing processes in particular include processes which are suitable for the production of prototypes (rapid prototyping) and structural components (rapid manufacturing), preferably from the group formed by powder-based manufacturing processes, particularly preferably the powder bed-based processes including laser sintering, high speed sintering, binder jetting, multi jet fusion, selective mask sintering, selective laser melting or laser pro fusion. Preferably, a solidification is carried out by the action of electromagnetic radiation. In particular, however, the composition in accordance with the invention is provided for use in laser sintering or laser pro fusion. The term “laser sintering” herein should be understood to be synonymous with the term “selective laser sintering” (SLS).

Furthermore, the present invention concerns a process for the production of a composition in accordance with the invention, wherein the process comprises at least the following steps:
(i) providing at least one polymer material, wherein the polymer material is selected from at least one thermoplastic polymer,
(ii) bringing together, in particular mixing, the polymer material with a moderate solvent, preferably at a first temperature, wherein at the first temperature, the moderate solvent does not dissolve the at least one polymer or dissolves it to no more than 5% by weight and wherein at a second temperature, which is higher than the first temperature, the moderate solvent at least partially dissolves the one polymer, preferably to more than 70% by weight, preferentially to more than 80% by weight, more preferentially to more than 90% by weight, particularly preferentially to more than 95% by weight, in particular to more than 98% by weight, especially preferentially to more than 99% by weight, most preferentially to more than 99.9% by weight,
(iii) heating the polymer-solvent mixture obtained in this manner, preferably with stirring, at least up to the second temperature, in order to at least partially dissolve the polymer in the solvent,
(iv) holding the polymer-solvent mixture isothermally at at least the second temperature, preferably for a period of 15 minutes and with stirring,
(v) cooling the polymer-solvent mixture, preferably with stirring, preferably to at least a third temperature, in order to precipitate the polymer out of the solvent, and
(vi) obtaining the powdered material.

Advantageously, with the aid of the process in accordance with the invention, a composition can be obtained which has a melting temperature of the polymer of at least 280° C., preferably at least 290° C., more preferably at least 300° C. The highest melting temperature of the composition is up to 400° C., preferably up to 375° C., particularly preferably up to 350° C.

Furthermore, a composition of this type has a specific melting enthalpy of the polymer of at least 28 J/g, preferably at least 30 J/g, more preferably at least 35 J/g. The highest specific melting enthalpy of the composition is up to 150 J/g, preferably up to 125 J/g, preferentially up to 100 J/g.

The term “provide” as used here should be understood to mean on-site manufacture as well as delivery of a polymer or a polymer material.

The designation “bring together” within the meaning of the aforementioned step ii) stands here for “bringing into contact”.

The designations “mix” and “admix” will be used synonymously below. A mixing or admixing procedure may be carried out in a disperser and/or in a mixer and also, if appropriate, encompasses process operations such as melting, dispersing, etc, for example.

Preferably, bringing together or mixing of the polymer material with the moderate solvent is carried out at a first temperature, wherein at the first temperature, the moderate solvent does not dissolve the at least one polymer, i.e. does not constitute a solvent for the polymer material, and wherein at a second temperature which is higher than the first temperature, the moderate solvent at least partially dissolves the polymer, i.e. is a solvent for the polymer material.

In principle, heating the mixture of the polymer material and the moderate solvent may be carried out to a temperature above or below the glass transition temperature of the at least one polymer or polymer material. Preferably, the mixture of the polymer material and the moderate solvent is heated to a temperature above the glass transition temperature of the polymer material. The term “glass transition temperature” in this case should be understood to mean the temperature at which a polymer is transformed into a rubbery to viscous state. The determination of the glass transition temperature is known to the person skilled in the art and could, for example, be carried out by means of DSC in accordance with DIN EN ISO 11357 (2:2020-08).

Preferably, the first temperature is room temperature, the second temperature is preferably in a range from 60° C. below the glass transition temperature to 100° C. above the glass transition temperature, preferably 70° C. above the glass transition temperature of the polymer; a third temperature is advantageously below the glass transition temperature, preferentially 130° C. below the glass transition temperature, particularly preferentially 5° C. below the glass transition temperature.

The third temperature is preferentially below the second temperature. In this case, the second and the third temperature are dependent on the polymer loading which is set and may, for example, be determined by establishing a cloud point diagram. To this end, the polymer is brought together with the moderate solvent in a specific ratio in a high pressure high temperature cell (for example PDE-140-LL, from Eurotechnica) and the system is heated until the polymer has visually dissolved completely in the medium (temperature gradient 9 K/min); this temperature is held constant for 15 min. During the subsequent continuous cooling at a temperature gradient of −2 K/min, preferably −1.5 K/min, the temperature at which clouding of the system commences is visually determined. The third temperature for exactly this ratio of polymer to moderate solvent is below this cloud point.

After the complete precipitation of the polymer (i.e. no more clouding can be seen), the system is then once again heated at a constant temperature gradient of 9 K/min and the temperature at which no more clouding can be seen is determined. The second temperature is above this determined temperature for exactly this ratio of polymer to moderate solvent.

Preferably, heating of the mixture of the polymer and the moderate solvent is carried out with stirring in a closed vessel, preferably without pressure compensation. In particular, the pressure here corresponds to the vapour pressure of the moderate solvent at the operating temperature. Optionally, an additional pressurization, for example with inert gases, may be carried out.

A subsequent cooling of the mixture is preferably carried out to at least a third temperature, in order to precipitate the polymer out of the solvent in a controlled manner. Cooling may optionally be carried out here by introducing shear forces, for example by stirring. The particle size distribution may be influenced in this manner, or it can specifically adjust it.

Preferably, in addition, a manufacturing process of this type can purify the polymer. By means of a purification step of this type, low molecular weight components (VOC: volatile organic compounds and/or residual monomers, dimers, trimers, etc) which are in the polymer material in the aforementioned step i) may be dissolved in the solvent after cooling and precipitation in accordance with step v). In this manner, the powdered material in step vi) reaches a higher degree of purity and has a lower concentration of these components.

Preferably, after purification, at least 1% by weight of the VOCs, particularly preferably 5% by weight of the VOCs, in particular 10% by weight of the VOCs, are dissolved in the solvent. At most 100% by weight of the VOCs are dissolved in the solvent.

Particularly preferably, such a purification step takes place with the addition of acetophenone as the solvent.

Such low molecular weight components can have a disruptive effect on the process for the production of the structural component from certain concentrations. An example is that they outgas from the non-powdered material during the layer by layer construction procedure in the process chamber and then are deposited in colder regions of the equipment or in the system for additive manufacture and therefore lead to contamination of the manufacturing system, in particular of the laser window. This may be linked to a loss of the laser power over the overall build height. Such low molecular weight components may also lead to the fact that during melting of the powdered material, they outgas and therefore lead to a higher porosity in the structural component.

If the composition in accordance with the invention is packaged, a packaging procedure may advantageously be carried out with the exclusion of moisture or under a controlled humidity in order, for example, to prevent the powder from becoming electrostatically charged. A composition produced in accordance with the process of the invention is therefore advantageously used as a consolidatable powdered material in a process for the layer by layer manufacture of a three-dimensional object from the powdered material, in which the successive layers of the object to be formed from this consolidatable powdered material are consolidated in succession at appropriate or specified sites by the input of energy, preferably electromagnetic radiation, in particular by the input of laser light.

The present invention also encompasses a composition, in particular for laser sintering processes, which can be obtained or is obtained using the process described above.

Finally, a composition in accordance with the invention is used for the production of a structural component, in particular a three-dimensional object, by layer by layer application and selective consolidation of a construction material, preferably a powder. In this regard, the designation “consolidation” should be understood to mean an at least partial melting with subsequent solidification or re-consolidation of the construction material.

In this regard, an advantageous process for the production of a structural component has at least the following steps:
(i) applying a layer of a composition in accordance with the invention and/or a composition produced according to a process in accordance with the invention, preferably a powder, to a construction area,
(ii) selectively consolidating the applied layer of the composition at positions which correspond to a cross section of the object to be produced, preferably by means of an irradiation unit, and
(iii) dropping the carrier down and repeating the steps of application and of consolidation until the structural component, in particular the three-dimensional object, has been completed.

The term “construction material” should be understood in the context of the present patent application to mean a powder or a consolidatable powdered material which can be consolidated by means of additive manufacturing processes, preferably by means of powder bed-based processes, in particular by means of laser sintering or laser melting, to form shaped articles or 3D objects. The composition in accordance with the invention is particularly suitable as a construction material of this type.

A plane which is located on a carrier inside a machine for additive manufacture at a specific distance from an irradiation unit which is mounted above it and which is suitable for consolidating the construction material serves as the construction area. The construction material is positioned on the carrier in a manner such that its uppermost layer is aligned with the plane which is to be consolidated. In this regard, during the manufacturing process, in particular during the laser sintering, the carrier can be set in a manner such that each newly applied layer of the construction material is at the same distance from the irradiation unit, preferably a laser, and can be consolidated in this manner by the action of the irradiation unit.

Advantageously a structural component which has been produced from the composition in accordance with the invention is at least substantially in the amorphous or completely amorphous form. A structural component of this type is characterized in that at a heating rate of 20 K/min, it has a specific melting enthalpy of less than 5 J/g, preferably less than 2 J/g, in particular less than 1 J/g, measured using DSC in accordance with DIN EN ISO 11357-3:2018-07.

A structural component, in particular a 3D object which has been produced from the composition in accordance with the invention, also has an advantageous tensile strength and elongation at break. The tensile strength here characterizes the maximum tensile stress which can occur in the substance. The determination of the tensile strength is known to the person skilled in the art and may, for example, be determined according to DIN EN ISO 527. The elongation at break characterizes the deformability of a substance in the plastic region (also known as ductility) to breakage and can be determined from DIN EN ISO 527-2, for example.

Furthermore, a structural component which has been manufactured from the composition in accordance with the invention has an improved dimensional tolerance and/or a reduced component distortion. The term “dimensional tolerance” here should be understood to mean that the actual measurement of a substance lies within the agreed allowable error or tolerance from the specified nominal mass. Furthermore, the term indicates the stability of a substance, for example having regard to stretching and shrinkage. Examples of frequent causes of changes in dimensions are temperature, pressure or tensile forces, aging or humidity.

Preferably, a structural component, in particular a three-dimensional object which is manufactured from the composition in accordance with the invention, has a density (in accordance with DIN ISO 1183) of more than 1.15 g/cm³, preferentially more than 1.20 g/cm³, particularly preferentially more than 1.23 g/cm³, in particular more than 1.26 g/cm³ and especially preferentially more than 1.29 g/cm³. At most, a structural component of this type has a density of 1.40 g/cm³, preferentially at most 1.35 g/cm³, especially preferentially at most 1.30 g/cm³. The aforementioned values are preferably for a structural component which is produced from a polymer or a composition without fillers.

In accordance with a further preferred embodiment, an advantageous structural component, in particular a three-dimensional object, has a porosity of less than 10%, preferentially less than 5%, particularly preferentially less than 3%, in particular less than 2%, especially preferentially less than 1%. The determination of the porosity of structural components is known to the person skilled in the art and may, for example, be measured via the density of the three-dimensional objects produced in accordance with DIN ISO 1183 (corresponds to Archimedes' Principle) on a balance (Kern, type 770-60) with a YDK 01 Sartorius density determination kit.

The present invention also encompasses a structural component which can be obtained or is obtained by the aforementioned process.

The composition in accordance with the invention may be used in rapid prototyping as well as in rapid manufacturing. In this regard, for example, additive manufacturing processes, are used which are preferably from the group formed by powder-based processes, particularly preferably from the group formed by powder-based processes (comprising laser sintering, laser pro fusion, high speed sintering, multi jet fusion, binder jetting, selective mask sintering, selective laser melting), in particular for use in technologies which consolidate the material by means of electromagnetic radiation, optionally and if appropriate with the aid of absorbers, more preferably for use in laser sintering or in a laser pro fusion process. Prototypes or production components may advantageously be produced by this process in a time-saving and cost-effective manner.

The term “rapid manufacturing” in particular means processes for the production of structural components, i.e. the production of more than one identical part in which, however, the production by means of an injection moulding tool, for example, is not economical or not possible because of the geometry of the structural component, above all if the parts have a very complex shape. Examples in this regard are parts for luxury cars, race cars or rally cars which are only manufactured in small quantities, or replacement parts for motor sports in which, in addition to the small quantities, the time point at which it is available is of significance. Areas in which the parts in accordance with the invention can be used may, for example, be the aerospace industry, medical technology, mechanical engineering, automobile construction, the sports industry, the household goods industry, electrical industry or lifestyle industry. The production of a plurality of simultaneous structural components, for example of personalised structural components such as prostheses, (inner ear) hearing aids and the like, for which the geometry can be individually tailored to the wearer, are also of significance.

Finally, the present invention comprises a composition as a consolidatable powdered material in a process for the layer by layer production of a three-dimensional object from powdered material, in which successive layers of the object to be formed are consolidated from this consolidatable powdered material one after the other in appropriate positions by the input of energy, preferably by an input of electromagnetic radiation, in particular by the input of laser light.

More particularly advantageous embodiments and refinements of the invention are defined in the dependent claims as well as in the description below, wherein the patent claims of one specific category can also refine the dependent claims of another category and features of different exemplary embodiments may be combined to form new exemplary embodiments.

In accordance with a preferred embodiment, an advantageous composition comprises a thermoplastic polymer which is selected from at least one polyetherimide, polycarbonate, polyarylethersulphone, polyphenylene oxide, acrylonitrile-butadiene-styrene copolymerisate, acrylonitrile-styrene-acrylate copolymerisate, polyvinylchloride, polyacrylate, polyester, polyamide, polyaryletherketone, polyether, polyurethane, polyimide, polyamideimide, polyolefin, polyarylene sulphide, polysiloxane as well as their copolymers and/or at least one polymer blend based on the polymers and/or copolymers cited above.

Preferably, the thermoplastic polymer is selected from at least a polyetherimide, a polyarylethersulphone and/or from at least one polymer blend of at least a polyetherimide and/or a polyarylethersulphone and at least one further polymer.

The at least one polymer is preferably selected from at least one homopolymer and/or heteropolymer and/or from a polymer blend, wherein the at least one homopolymer and/or heteropolymer particularly preferably comprises an amorphous homopolymer and/or heteropolymer. Preferably, a polymer blend comprises at least two amorphous homopolymers and/or heteropolymers or at least one partially crystalline homopolymer and/or heteropolymer and at least one arrangement homopolymer and/or heteropolymer. Particularly preferably, the polymer blend contains at least two amorphous homopolymers and/or heteropolymers.

In particular, the at least one homopolymer and/or heteropolymer and/or polymer blend is selected from at least one amorphous polymer or an amorphous copolymer or a partially crystalline polymer blend of at least one partially crystalline polymer and at least one further amorphous polymer or an amorphous polymer blend of at least two amorphous polymers.

The term “partially crystalline” in the present case should be understood to mean a material which contains both crystalline as well as amorphous regions. In particular, a polymer is then considered to be partially crystalline when it is not amorphous and is less than 100%, preferably less than 99% crystalline.

Preferably, the heteropolymer or copolymer has at least two different repeating units.

A composition in accordance with the invention preferably comprises a polymer and/or a copolymer and/or a polymer blend with a melting temperature of up to 335° C., preferably up to 330° C., more preferably up to 325° C. A preferred polymer has a melting temperature of at least 285° C., preferentially at least 300° C., more preferentially at least 310° C., yet more preferentially at least 320° C., particularly preferentially at least 323° C., especially preferentially approximately 324° C. In the present description, when the term “at least approximately” or “at most approximately” or “up to approximately”, etc is used in connection with the melting temperature, this means that the cited numerical value has a possible error of ±2° C.

In particular, the term “approximately” or “to approximately” in the present description pertains to the exact values at these or other passages of the text.

More preferably, a composition has a melting enthalpy of up to approximately 150 J/g, preferably up to approximately 100 J/g, more preferably up to approximately 50 J/g, particularly preferably up to approximately 38 J/g. At least the composition has a melting enthalpy of at least approximately 28 J/g, preferentially at least approximately 30 J/g, particularly preferentially at least approximately 32 J/g, especially preferentially at least approximately 33 J/g, more preferentially at least approximately 34 J/g and/or 35 J/g, most preferentially approximately 36 J/g. In the present description, when the term “at least approximately” or “at most approximately” or “up to approximately” (etc.) is used in connection with the melting enthalpy, this means that the cited numerical value has a possible error of ±2° C.

Particularly preferably, such melting temperatures and melting enthalpies are for PEI.

In accordance with a preferred composition, the thermoplastic polymer is selected from at least one polyetherimide. Particularly preferably in this regard, the polyetherimide has repeating units in accordance with

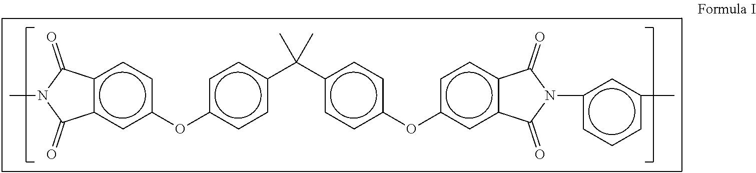

and/or repeating units in accordance with

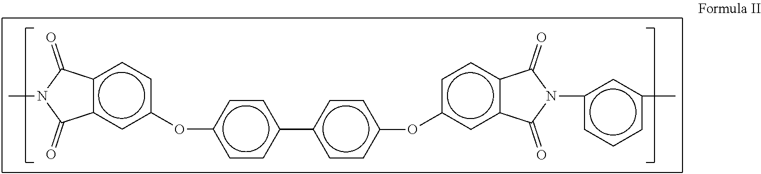

and/or repeating units in accordance with

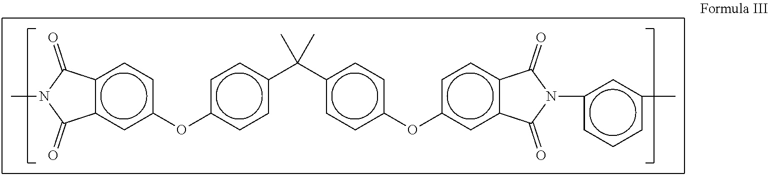

The number n of repeating units in accordance with Formula I, II and III in this regard is more preferably at least 10 and/or up to at most 1000. Preferably, the polyetherimide has repeating units with Formula III.

Preferably, the molecular weight of such a polyetherimide is at least 5000 u, preferably at least 10000 u, particularly preferably at least 15000 u and/or at most 200000 u, in particular at least 15000 u and/or at most 100000 u. The weight average molecular weight of such a preferred polymer is preferably at least 20000 u, particularly preferably at least 30000 u and/or at most 500000 u, in particular at least 30000 u and/or at most 200000 u.

A preferred example of a polyetherimide in accordance with Formula I is available under the trade names Ultem® 1000, Ultem® 1010 and Ultem® 1040 (Sabic, Germany). An example of a preferred polyetherimide in accordance with Formula III is available under the trade names Ultem® 5001 and Ultem® 5011 (Sabic, Germany).

In accordance with a preferred composition, the thermoplastic polymer is selected from at least one polyarylethersulphone. Particularly preferably in this regard, it is a polyethersulphone (PESU), polysulphone (PSU) and/or polyphenylenesulphone (PPSU) with the following structural formulae:

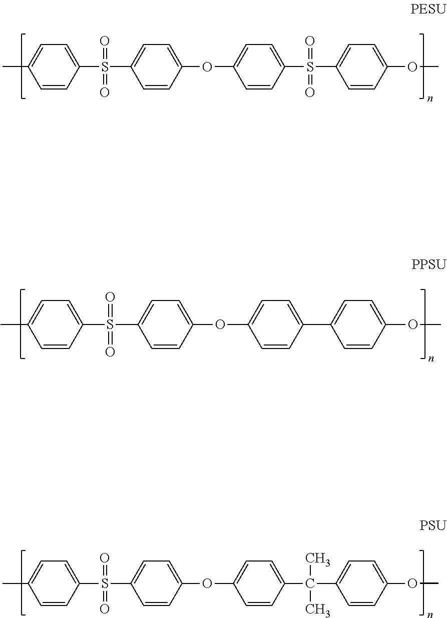

The number n of the repeating units in this regard is preferably at least 10 and/or up to at most 1000.

Preferably, the molecular weight of such a polyarylethersulphone is at least 5000 u, preferably at least 10000 u, particularly preferably at least 15000 u and/or at most 200000 u, in particular at least 15000 u and/or at most 100000 u. The weight average molecular weight of such a preferred polymer is preferably at least 20000 u, particularly preferably at least 30000 u and/or at most 500000 u, in particular at least 30000 u and/or at most 200000 u.

An example of a preferred polyarylethersulphone is available under the trade name Ultrason® (BASF, Germany). An example of a preferred polyethersulphone is available under the trade name Ultrason® E2010 (BASF, Germany).

A further preferred composition in this regard comprises a polymer blend comprising a polyaryletherketone-polyetherimide, preferably a polyetherketoneketone, particularly preferably a polyetherketoneketone with a terephthalic acid:isophthalic acid isomeric ratio between 65:35 and 55:45. In this regard, a preferred composition may have a polyetherimide which preferably contains the repeating units of Formula I.

Finally, a preferred composition may have a polycarbonate, in particular with the repeating unit with Formula IV:

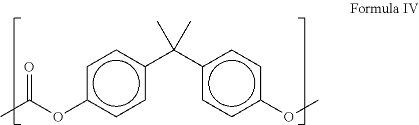

As explained above, the composition may be obtained by means of precipitation from a first moderate solvent or a mixture of the first and at least one further moderate solvent. In accordance with a preferred embodiment, the at least one or further moderate solvent is selected from at least one cyclic moderate solvent such as, for example, lactams, phenones, phenols, cycloalkanes and/or cycloalkanones. More preferably, the moderate solvent is selected from a homocyclic moderate solvent such as, for example, from benzene, cyclohexanone, acetophenone, phthalic acid ester, and/or a heterocyclic moderate solvent such as, for example, thiophenes and/or cyclic ethers, particularly preferably from an aromatic homocyclic moderate solvent such as acetophenone, dimethylphthalate and/or benzene, in particular from an aromatic, non-halogenated homocylic moderate solvent.

In respect of the selection of a suitable moderate solvent, the Hansen solubility parameter may be used. The Hansen solubility parameter δ_{T} can be calculated using the formula δ_{T}²=δ_{D}²+δ_{P}²+δ_{H}² or by using HSPiP software (Dr. techn. Charles M. Hansen, Jens Bornøsvej 16, 2970 Hørsholm, Denmark or via www.hansen-solubility.com). Here, the terms “Hansen solubility parameter” and “solubility parameter” will be used synonymously.

In accordance with a preferred embodiment, the moderate solvent has a solubility parameter which is at least 10 MPa^{1/2} smaller, preferably at least 8 MPa^{1/2} smaller, more preferably at least 5 MPa^{1/2} smaller and/or at most 10 MPa^{1/2} higher, preferably at most 8 MPa^{1/2} higher, more preferably at most 5 MPa^{1/2} higher than a solubility parameter of the at least one polymer. In particular, the solubility parameters of the moderate solvent and of the polymer are at least substantially identical. The designation “substantially” in this case signifies that the solubility parameter of the moderate solvent and the solubility parameter of the polymer differ by no more than 10 MPa^{1/2}, more preferably by no more than 8 MPa^{1/2}, particularly preferably by no more than 6 MPa^{1/2}, in particular by no more than 5 MPa^{1/2}.

Particularly preferably, the at least one or further moderate solvent is selected from dimethylphthalate and/or acetophenone.

In accordance with a further preferred embodiment, an advantageous composition comprises at least one auxiliary substance, wherein the auxiliary substance is preferably selected from an additive and/or a filler.

The additive is preferably selected from the group formed by heat stabilizers, oxidation stabilizers, UV stabilizers, colorants, plasticizers, IR absorbers, SiO₂ particles, carbon black particles, inorganic and/or organic pigments and/or flame retardants (in particular phosphate-containing flame retardants such as red phosphorus, ammonium polyphosphate and/or brominated flame retardants and/or other halogenated flame retardants and/or inorganic flame retardants such as magnesium hydroxide or aluminium hydroxide).

The filler group preferably comprises reinforcing fibres, SiO₂ particles, metal oxides, calcium carbonate, carbon fibres, glass fibres, carbon nanotubes, mineral fibres (for example wollastonite), aramid fibres (in particular Kevlar fibres), glass beads and/or mineral fillers.

Other preferred auxiliary substances include polysiloxanes. Polysiloxanes may, for example, act as flow additives in order to reduce the viscosity of the polymer melt and/or in particular as a plasticizer in polymer blends.

Preferably, the auxiliary substance content in the composition in accordance with the invention may be at least 0.01% by weight and/or at most 90% by weight, preferably at least 0.01% by weight and/or at most 50% by weight.

For additives such as oxidation stabilizers, UV stabilizers or colorants, the content is more preferably at least 0.01% by weight and/or at most 5% by weight, in particular at least 0.01% by weight and/or at most 2% by weight. For IR absorbers, the content is preferably at least 0.01% by weight and/or at most 1% by weight, more preferably at least 0.01% by weight and/or at most 0.5% by weight, particularly preferably at least 0.02% by weight and/or at most 0.2% by weight, in particular at least 0.02% by weight and/or at most 0.1% by weight.

The amount of a filler in the composition in accordance with the invention may preferably be at least approximately 1% by weight and/or at most approximately 90% by weight, preferably at least 5% by weight and/or at most 50% by weight, particularly preferably at least 10% by weight and/or at most 40% by weight.

Polymer systems often have a partial positive and/or negative charge. Particularly when particles of the polymer system have different charges at different positions on the surface, interactions can arise, for example through electrostatic, magnetic and/or Van der Waals forces between adjacent particles, which result in an unwanted agglomeration of the polymer system particles.

In accordance with a further preferred embodiment, an advantageous composition therefore comprises at least one anti-agglomeration agent. The term “anti-agglomeration agent” here should be understood to be synonymous with the designation “anti-caking agent”. In the present patent application, an “anti-agglomeration agent” should be understood to be a material in the form of particles which can be deposited on and/or into the polymer particles.

The term “deposition” as used here should be understood to mean that particles of the anti-agglomeration agent accumulate, for example through electrostatic forces, chemical bonds (for example ionic and covalent bonds) and hydrogen bonds and/or magnetic forces and/or Van der Waals forces interact with particles of the polymer or the polymer system and therefore come relatively close spatially, so that particles of the polymer system advantageously do not come into direct contact with each other, but are separated from each other by particles of the anti-agglomeration agent. In general, the polymer system particles which are spatially separated in this manner have weak or no interactions with each other, so that the addition of anti-agglomeration agents advantageously counteracts clumping of the composition.

In accordance with a preferred embodiment, an advantageous composition therefore comprises at least one anti-agglomeration agent. An anti-agglomeration agent of this type may be selected from the group formed by metal soaps, preferably produced from a silicon dioxide, stearate, tricalcium phosphate, calcium silicate, aluminium oxide, magnesium oxide, magnesium carbonate, zinc oxide or mixtures thereof.

In accordance with a further preferred embodiment, a first anti-agglomeration agent comprises silicon dioxide. This may be a silicon dioxide which has been produced by a wet chemical precipitation process, or pyrogenic silicon dioxide. Particularly preferably, however, the silicon dioxide is pyrogenic silicon dioxide.

In the present patent application, the term “pyrogenic silicon dioxide” should be understood to mean silicon dioxide which has been manufactured using known processes, for example by flame hydrolysis by means of the addition of liquid tetrachlorosilane to the hydrogen flame. Silicon dioxide will also be described below as silica.

In accordance with a further preferred embodiment, a composition in accordance with the invention comprises a second anti-agglomeration agent and therefore advantageously enables an improved adjustment of the physical properties, for example as regards the electrostatic, magnetic and/or Van der Waals forces in the anti-agglomeration agent, to the polymer or polymers, and therefore improves the processability of the composition, in particular in laser sintering processes.

In accordance with a particularly preferred embodiment, the second anti-agglomeration agent is also a silicon dioxide, in particular pyrogenic silicon dioxide.

Clearly, a composition in accordance with the invention may also have more than two anti-agglomeration agents.

In this regard, in an advantageous composition, a preferred proportion of the at least one anti-agglomeration agent is at most 1% by weight, more preferentially at most 0.5% by weight, particularly preferentially at most 0.2% by weight, in particular at most 0.15% by weight, particularly preferentially at most 0.1% by weight. The proportion in this regard refers to the proportion of all of the anti-agglomeration agents contained in the advantageous composition.

In principle, the at least one or the two or more anti-agglomeration agent(s) may be treated with one or even with a plurality of different hydrophobic agents. In accordance with a further preferred embodiment, the anti-agglomeration agent has a hydrophobic surface. A substance based on organosilanes may be used to make the surface hydrophobic.

Furthermore, the anti-agglomeration agent may advantageously effectively prevent caking and therefore aggregation of particles of the polymer system in the composition and counteracts the formation of voids when pouring, whereupon the bulk density of the composition is advantageously increased. The bulk density can be influenced by its particle size or particle diameter and properties of the particle.

The term “bulk density” as used here should be understood to be the ratio of the mass of a granular solid which has been densified by pouring and not, for example, by stamping or shaking, to the bulk volume that it takes up. The determination of the bulk density is known to the person skilled in the art and may, for example, be carried out in accordance with DIN EN ISO 60-2000-01.

A particularly advantageous composition has a bulk density of at least 350 kg/m³ and/or at most 700 kg/m³. The bulk density here is that of the composition in accordance with the invention.

In the case of the aforementioned additive manufacturing process, powder with a relatively round grain shape is required, because angular particles can give rise to striations when the powder layers are applied, which would in particular make an automated construction process more difficult and would deteriorate the quality of the structural components produced in this manner, in particular its density and the nature of its surface. However, there is a problem with obtaining polymers or copolymers in the form of round particles.

Advantageously, round particles can be obtained with the composition in accordance with the invention.

In general, for compositions which are used in laser sintering processes, an appropriate grain size or grain size distribution, a suitable bulk density as well as a sufficient pourability of the powdered material is of significance.

The term “grain size” describes the size of individual particles or grains in a total amount. The grain or particle size distribution in this regard has an influence on the material properties of a bulk material, i.e. the total amount of the grains which are in a pourable form, for example in a powdered composition.

In accordance with a further preferred embodiment, the particles of an advantageous composition have a grain size distribution
d10=at least 10 μm, preferably at least 15 μm and/or at most 50 μm, preferably at most 40 μm
d50=at least 20 μm and/or at most 100 μm, preferably at least 30 μm and/or at most 80 μm, particularly preferably at least 30 μm and/or at most 60 μm
d90=at least 35 μm and/or at most 150 μm, preferably at most 120 μm.

Methods for determining the grain size or the grain size distribution are known to the person skilled in the art. Thus, a measurement may, for example, be carried out using a Camsizer XT instrument and the X-Jet module (Retsch Technology GmbH) with the associated CamsizerXT64 (Version 6.6.11.1069) software. The optical methods for determining the grain size and particle shape are based on the ISO 13322-2 standard. In this regard, the approximately 2 g sample is dispersed with 30 kPa compressed air and guided through a 4 mm wide aperture to a calibrated optical unit with two differently magnifying cameras (“basic” and “zoom”). At least 10000 individual images are recorded for the analysis. In order to ensure a good optical separation of the particles, images are only used if the surface density of the recorded particle is under 3% (“basic” camera) or under 5% (“zoom” camera). The sizes and shapes of the particles are determined with the aid of defined measurement parameters. The determined size is the equivalent diameter of the circle with the same area as the particle projection, x_area=√(4A/π). The median value or mean value for this evaluation method is comparable with the laser diffraction (given as d10, d50 and d90, i.e. as the 10% quantile, 50% quantile and 90% quantile of the volumetric particle size distribution). The measurement is repeated several times in order to form a statistical measured value.

In accordance with a preferred embodiment, an advantageous composition has a distribution width (d90−d10)/d50 of at most 3, more preferably at most 2, particularly preferably at most 1.5, in particular at most 1.

A further preferred composition has a proportion of fines, i.e. a proportion of particles with a particle size of less than 10 μm, of below 10% by weight, more preferably below 6% by weight, in particular below 4% by weight.

The polymer particles of the composition in accordance with the invention preferably have an at least substantially spherical to lenticular shape or form. Particularly preferably, the polymer particles of a particularly advantageous composition have a sphericity of at least 0.7, preferably at least 0.8, in particular at least 0.85. The determination of the sphericity may, for example, be carried out with the aid of microscopy (in accordance with DIN ISO 13322-1) and/or with the aid of a measuring instrument of the Camsizer XT type (Retsch Technology, Germany) in accordance with DIN ISO 13322-2.

Furthermore, it has been shown to be advantageous for the particles of a composition in accordance with the invention to have as small a specific surface area as possible. As an example, the specific surface area may be determined by gas adsorption in accordance with Brunauer, Emmet and Teller's principle (BET); the associated standard is DIN EN ISO 9277. The specific surface area of the particles determined in accordance with this method is also known as the BET specific surface area.

In accordance with a preferred embodiment, the BET specific surface area of an advantageous composition is at least 0.1 m²/g, preferably at least 0.5 m²/g, particularly preferably at least 1 m²/g. At most, a BET specific surface area of a preferred composition is 20 m²/g, particularly preferably at most 10 m²/g, in particular at most 5 m²/g, particularly preferably at most 3 m²/g. A preferred BET specific surface area in this case is at least 0.5 m²/g and/or up to 2 m²/g.

A process for the production of an advantageous composition, in particular a powdered material, comprises at least one of the following steps in addition to the aforementioned steps:
(a) adding at least one first auxiliary substance to the polymer or the polymer-solvent mixture in accordance with the aforementioned step ii) or iii), and/or
(b) adding at least one first auxiliary substance and/or anti-agglomeration agent to the powdered polymer material.

In principle, the auxiliary substance can therefore be added to the polymer-solvent mixture in accordance with the aforementioned step (a) or the auxiliary substance and/or the anti-agglomeration agent can be added to the powdered polymer material in accordance with step (b). However, preferably, an addition of the at least one first auxiliary substance to the polymer or to the polymer-solvent mixture is carried out in accordance with the aforementioned step (a). Thus, the addition of the auxiliary substance may, for example, be carried out by compounding, i.e. admixing the auxiliary substance or auxiliary substances (for example in an extruder) in order to obtain the desired property profile.

In accordance with a further preferred embodiment, the auxiliary substance is selected in a manner such that it does not dissolve in the solvent, but in the polymer. A procedure of this type advantageously ensures that the auxiliary substance is present in the grain after the precipitation process.

As an alternative or in addition, the addition of the at least one auxiliary substance to the powdered polymer material may be carried out in accordance with step (b). Preferably here, an addition of the at least one first auxiliary substance to the powdered material is carried out after the manufacture of the powder, i.e. after removing the solvent and, if appropriate, after drying the powder.

If one or more anti-agglomeration agents are added, as described above, the addition to the powdered material is carried out in accordance with step (b). Preferably, an addition of this type is carried out after removal of the solvent and, if appropriate, after drying the powder.

In accordance with a preferred process, the polymer-solvent mixture comprises at least 1% by weight of the at least one thermoplastic polymer, preferably at least 5% by weight, more preferably at least 10% by weight. The preferred polymer-solvent mixture contains at most 50% by weight, preferably at most 40% by weight, more preferably at most 30% by weight, more preferentially at most 25% by weight, in particular at most 20% by weight, especially preferentially at most 15% by weight, of the at least one thermoplastic polymer.

A particularly preferred process for the production of a composition or of a powdered material uses a moderate solvent which is selected from at least one non-halogenated, aromatic moderate solvent.

In addition or as an alternative, a preferred moderate solvent has a Hansen solubility parameter of at least 15 δ, preferably at least 20 δ, and/or at most 35 δ, preferably at most 30 δ, particularly preferably approximately 25 δ.

A moderate solvent of this type here is particularly preferably selected from at least dimethylphthalate and/or acetophenone.

In particular, the powdered material or the thermoplastic polymer is a polyimide, preferably a polyetherimide or a polyarylethersulphone.

In a further preferred process for the production of an advantageous composition, the cooling of the polymer-solvent mixture, in particular from a second temperature to a third temperature, is carried out in a manner such that a cooling rate for the polymer-solvent mixture is obtained in a specific or controlled manner. Preferably, cooling is carried out at a cooling rate of at least 0.05° C./min, preferably at least 0.1° C./min, particularly preferably at least 0.5° C./min, in particular at least 1° C./min, particularly preferably at least 1.5° C./min. At most, cooling is carried out at a rate which is preferably 4° C./min, preferably at most 3° C./min, in particular at most 2° C./min.

Cooling of the mixture may, for example, take place in a reactor, such as an autoclave, for example, which is optionally equipped with a stirrer, and/or via a water/air cooling section which may extend over several metres. In this regard, a stirring procedure may be carried out, passively by convection or actively by stirring the mixture.

Subsequently, the polymer or the polymer particles is/are separated from the mixture and may, if necessary, involve washing and drying the separated polymer or polymer particles.

A separation of the components of the mixture is preferably carried out by centrifuging and/or filtration. Drying of the solid component in order to obtain the dried composition may be carried out in an oven, for example, for example in a vacuum dryer.

As already mentioned above, in a next step, an additive may be added to the composition in accordance with the invention. In particular, an additive of this type is selected from an anti-agglomeration agent. Preferably, an addition of the additive, in particular of an anti-agglomeration agent, is carried out in a mixer.

Finally, an advantageous production process may involve packaging the composition. Packaging of a composition produced in accordance with the process of the invention, in particular of sieved polymer particles, which are preferably in the form of a powder, is preferably carried out here with the exclusion of moisture of the air, so that subsequent storage of the composition in accordance with the invention may be carried out with a reduced moisture content in order to prevent caking effects, for example, whereupon the stability of the composition in accordance with the invention upon storage is improved. In addition, an advantageous packaging material prevents the ingress of moisture, in particular moisture from the air, into the composition in accordance with the invention.

As mentioned above, compositions in accordance with the invention are suitable for additive manufacturing processes, in particular for laser sintering processes. Usually, the target environment, for example the powder bed of the irradiation unit, in particular of the laser beam, is heated before use so that the temperature of the starting powdered material is close to its melting temperature and then only a small input of energy is sufficient to raise the overall energy input sufficiently for the particles to coalesce together or consolidate. Furthermore in this regard, energy-absorbing and/or energy-reflecting materials may be applied to the target environment of the irradiation unit which enable selective melting of the material at the sites to be consolidated.

As already mentioned above, in accordance with the advantageous process, a three-dimensional object is selectively consolidated by consolidation of the composition in accordance with the invention at predetermined positions by means of electromagnetic radiation which is emitted by a radiation source.

A further embodiment pertains to a system for the production of a three-dimensional object by consolidation of the composition in accordance with the invention at predetermined positions, wherein the system comprises at least one source of radiation for the emission of electromagnetic radiation. Furthermore, the system comprises a process chamber in the form of an open container with a wall, a carrier which is located in the process chamber, wherein the process chamber and the carrier are movable in the vertical direction with respect to each other, as well as a reservoir chamber which is movable in the horizontal direction and a recoater, wherein the reservoir chamber is at least partially filled with the composition in accordance with the invention.

In accordance with a preferred embodiment, the source of radiation emits light with a wavelength in the range from 500 nm to 1500 nm, preferably in a range of 1064±8 nm and/or 980±7 nm and/or 940±7 nm and/or 810±7 nm and/or 640±7 nm. As an alternative, the source of radiation may emit light with a wavelength of approximately 10.6 μm or in the range from 4.8 μm to 8.3 μm, preferably in a range of 5 μm.

Preferably, the source of radiation comprises at least one laser, in particular a diode laser.

The term “melting” as used here should be understood to means the process whereby the powder is at least partially melted during an additive manufacturing process, for example in a powder bed, by the input of energy, preferably by means of electromagnetic waves, in particular by laser energy. The composition in accordance with the invention or the process in accordance with the invention thereby ensures at least partial melting and a reliable process for the production of shaped articles with a high mechanical stability and dimensional tolerance. In accordance with a preferred embodiment, the composition in accordance with the invention or the process in accordance with the invention enables complete melting to be carried out.

It has also been shown that the tensile strength, the Young's modulus and the elongation at break of an advantageous structural component may be used as properties of the material or as a measure of the processability of the composition in accordance with the invention.

In accordance with a further preferred embodiment, an advantageous structural component which has been manufactured from a composition in accordance with the invention, in particular from a composition comprising a polyetherimide or a polyarylethersulphone, has a tensile strength parallel to the layer direction of at least 40 MPa, preferably at least 60 MPa, particularly preferably at least 70 MPa, in particular at least 80 MPa, especially preferably at least 90 MPa. At most, the preferred composition has a tensile strength parallel to the direction of the layers of 200 MPa, preferably at most 150 MPa, in particular at most 100 MPa.

Furthermore, an advantageous structural component produced from a polymer or from a composition without fillers, in particular from a polymer or a composition comprising a polyetherimide or a polyarylethersulphone, has a Young's modulus parallel to the layer direction of at least 1400 MPa, preferably at least 2000 MPa, yet more preferably at least 2400 MPa, in particular at least 2800 MPa and more specifically more than 3000 MPa. At most, the preferred composition parallel to the layer direction has a Young's modulus of 5000 MPa, more preferably at most 4000 MPa, in particular at most 3500 MPa.

Furthermore, an advantageous structural component which has preferably been produced from a composition comprising a polyetherimide or a polyarylethersulphone has an elongation at break parallel to the layer direction of at least 1%, particularly preferably at least 3%, in particular at least 5%, particularly preferably at least 7%. At most, a preferred structural component has an elongation at break of 100%, more preferentially at most 80%, particularly preferably at most 50%, in particular at most 25%. The determination of the tensile strength, the Young's modulus and the elongation at break may be determined using what is known as a tensile test in accordance with DIN EN ISO 527 (2-2019-12) and will be familiar to the person skilled in the art.

Furthermore, the metering capability of the composition in accordance with the invention in the cold or warm state in the laser sintering unit, its layer application and state of the powder bed in the cold or warm state, its layer application in the laser sintering process, preferably in the running laser sintering process, in particular its coating onto radiated surfaces and the dimensional tolerance and the mechanical properties of the specimen obtained may be evaluated.

Furthermore, it may be advantageous for the composition to comprise at least one auxiliary substance which enables the mechanical, electrical, magnetic, flame retardant and/or aesthetic powder or product properties to be adjusted. In a preferred embodiment, the composition comprises at least one organic and/or inorganic auxiliary substance such as, for example glass particles, particles of metal, for example aluminium and/or copper and/or iron particles, ceramic particles, metal oxides or pigments in order to change the colour, preferably titanium oxide or carbon black.

As an alternative or in addition, the auxiliary substance may also be selected from a fibre such as a carbon, glass and/or mineral fibre such as wollastonite, for example. The absorption behaviour of the powder can also be influenced in this manner. Fillers for adjusting the mechanical properties may also be selected from the group formed by metal oxides or from calcium carbonate. Flame retarding additives may, for example, be selected from the group comprising metal hydroxides such as magnesium hydroxide or aluminium hydroxide, phosphorus compounds such as red phosphorus or ammonium polyphosphate or bromine-containing flame retardants, for example.

Furthermore, it may be advantageous for the composition to comprise at least one auxiliary substance which is used for the thermo-oxidative stabilization of the polymer and/or for UV stabilization. It may, for example, be an antioxidant and/or a UV stabilizer. An antioxidant of this type which may, for example, be employed is known under the trade name Irganox or Irgafos from BASF (Ludwigshafen, Germany); an example of a UV stabilizer is that known under the trade name Tinuvin from BASF.

Furthermore, it may be advantageous for an IR absorber to be used as the auxiliary substance which absorbs in the wavelength range of the laser or of the infrared heating that is employed. This may, for example, be carbon black.

Further features of the invention will become apparent from the description below of exemplary embodiments made in connection with the claims. It should be pointed out here that the invention is not limited to the embodiments of the exemplary embodiments which have been described, but is defined by the scope of the accompanying claims. In particular, the individual features of embodiments of the invention may be embodied in other combinations than in the examples described below. The following description of some exemplary embodiments of the invention is made with reference to the accompanying figures, in which:

FIG. 1: shows DSC thermograms of a composition in accordance with the invention (as per V1) comprising polyetherimide (PEI, Ultem CRS5011, Sabic).

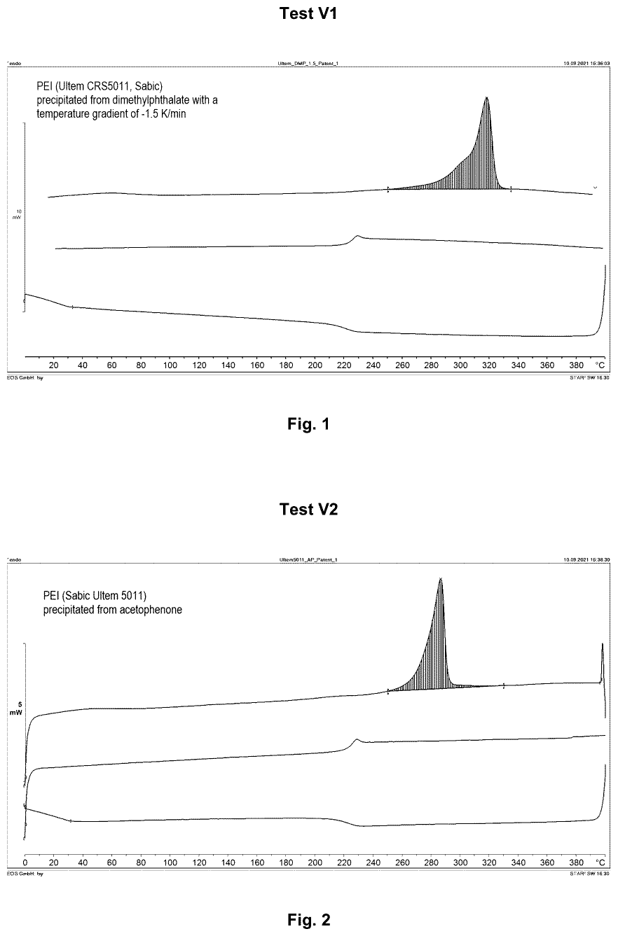

FIG. 2: shows DSC thermograms of a composition in accordance with the invention (as per V2) comprising polyetherimide (PEI, Ultem CRS5011, Sabic).

FIG. 3: shows a view of the placement of the structural component in the construction space (as per V1 and V2).

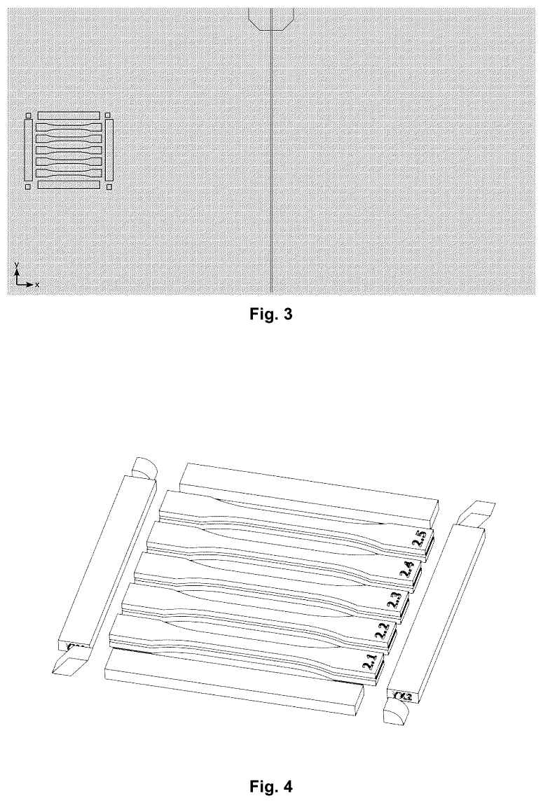

FIG. 4: shows an orthogonal view of the structural components (as per V1 and V2).

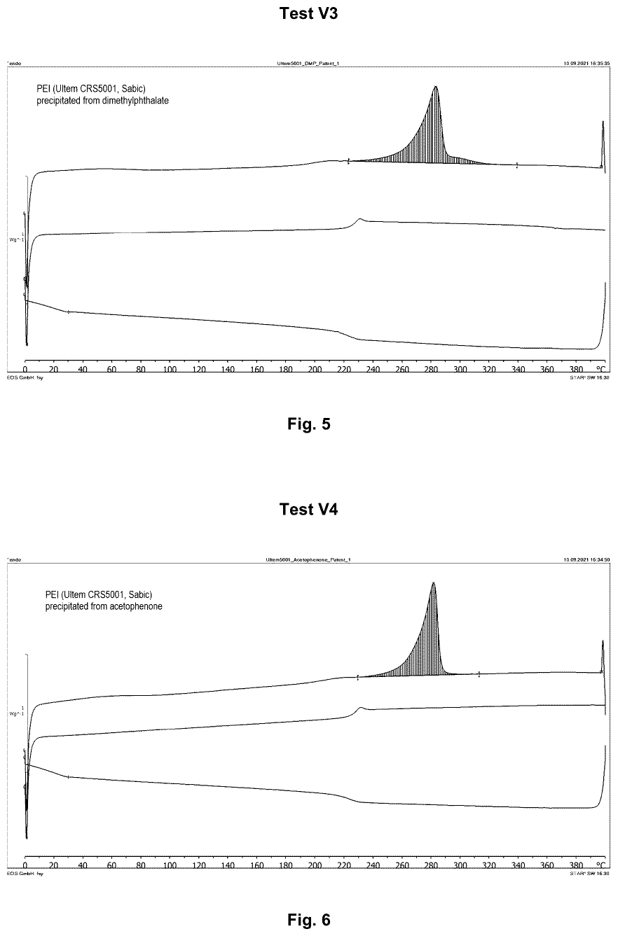

FIG. 5: shows DSC thermograms of a composition in accordance with the invention (as per V3) comprising polyetherimide (PEI, Ultem CRS5001, Sabic).

FIG. 6: shows DSC thermograms of a composition in accordance with the invention (as per V4) comprising polyetherimide (PEI, Ultem CRS5001, Sabic).

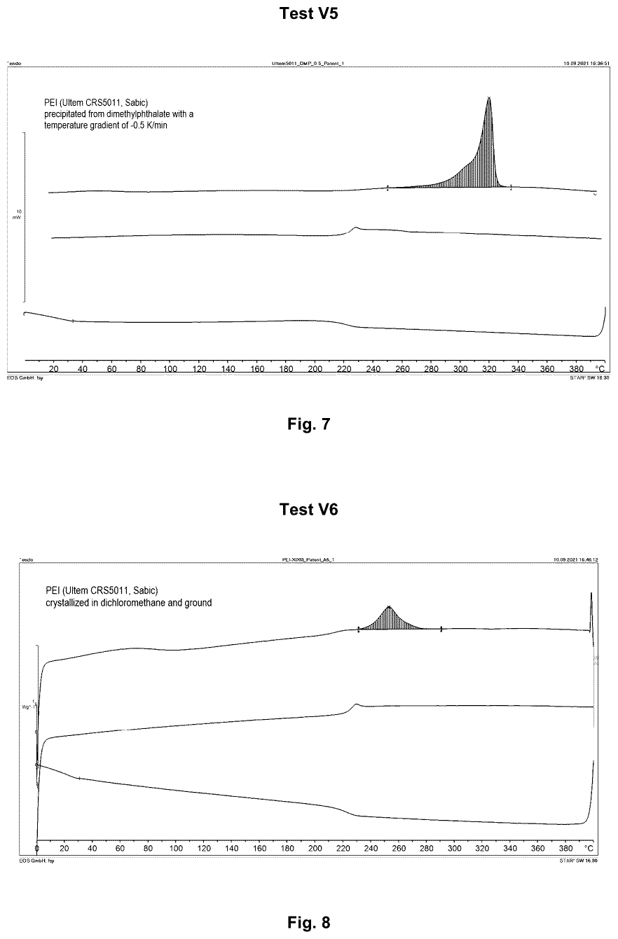

FIG. 7: shows DSC thermograms of a composition in accordance with the invention (as per V5) comprising polyetherimide (PEI, Ultem CRS5011, Sabic).

FIG. 8: shows DSC thermograms of a comparative example (as per V6) comprising polyetherimide (PEI, Ultem CRS5011, Sabic).

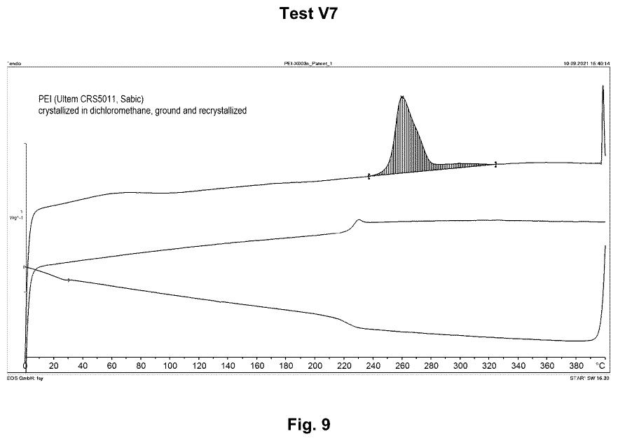

FIG. 9: shows DSC thermograms of a comparative example (as per V7) comprising polyetherimide (PEI, Ultem CRS5011, Sabic).

### EXAMPLES

### Examples V1 and V2

300 g of polyetherimide (PEI, trade name Sabic Ultem CRS5011, Sabic) and in 1700 g of moderate solvent (corresponding to a loading of 15% by weight) were placed in an autoclave (Versoklav 3, Buchi AG with 3L capacity and an integrated stirrer, pressurized to 200 bar and 300° C.) and heated, with stirring, (V1: 350 rpm stirrer speed; V2: 500 rpm stirrer speed) to a temperature of 260° C., whereupon the polymer dissolved in the solvent. The pressure set up here corresponded to the vapour pressure of the solvent. Next, the solution was cooled to 60° C. at a rotational speed of 350 rpm (V1) or 500 rpm (V2) with a temporal temperature gradient of −1.5 K/min, whereupon the polymer precipitated out of the solution. The solvent was separated out by filtration and the polymer powder was washed with ethanol and dried at 120° C. in a vacuum oven (VT 6130 P, Thermo Scientific, Thermo Electron LED GmbH, equipped with a MD 12H vacuum pump from Vacuubrand GmbH & Co KG) (85 mbar pressure) for at least 48 h.

The Hansen solubility parameter of the polymer was 28.9 MPa^{1/2}; those for the solvents dimethylphthalate and acetophenone were 24.2 MPa^{1/2} and 21.2 MPa^{1/2}.

The determination of the flow factor and the unconfined yield strength (UYS) was carried out with a RST 01.01 Schulze ring shear cell (Dr. Dietmar Schulze, Bulk Material Measurement, D6773-16), wherein consolidation stresses σ₁ of approximately 1200 Pa, 2400 Pa and 4600 Pa were applied to the sample. A uniaxial yield strength σ_{c} results as a function of σ₁. The quotient of the two parameters is defined as the flow function, ff_{c}, and is classified into five levels:
ff_{c}<1 not flowing
1≤ff_{c}≤2 very cohesive
2≤ff_{c}≤4 cohesive
4≤ff_{c}≤10 easy-flowing
10≤ff_{c} free-flowing

The conditioned bulk density (CBD) was determined with the aid of a FT4 powder rheometer (Freeman Technology Ltd). The CBD was measured in accordance with the manufacturer's instructions [see Manual W7008, Compressibility, Issue B, Freeman Technology Support Document, January 2006], with 60-65 g of sample and a conditioning period of >24h.

Under the cited conditions, a fine powder with a particle size distribution which was suitable for the laser sintering process could be obtained both from dimethylphthalate as well as from acetophenone (see Table 1 below).

In the case of a precipitation from dimethylphthalate, a powder with a mean particle size (D50) of 29.6 μm (distribution width 0.66) was obtained which had a melting point of 317.8° C. and a specific melting enthalpy of 42.8 J/g (see FIG. 1, upper curve; insofar as DSC measurements are shown in the examples below, the first heating cycle is uppermost, the second heating cycle is in the middle and the cooling program is shown below). An unconfined yield strength of 904 Pa and a ff_{c} of 4.8, determined with a Schultz ring shear cell, showed that the powder is very pourable (see Table 1 below).

The BET specific surface area of the powder obtained from the precipitation with dimethylphthalate was determined by means of gas adsorption using the Brunauer, Emmet and Teller (BET) principle in accordance with DIN EN ISO 9277. A value of 2.37 m²/g was obtained.

A powder with a melting point of 286.2° C. and a melting enthalpy of 34.4 J/g could be precipitated from acetophenone (see FIG. 2, upper curve), which was also well suited to the laser sintering process with a mean grain size of 40.7 μm (distribution width 0.89). Not only was the powder highly pourable (UYS of 1094 and ff_{c} of 4.0), it also had a comparatively high conditioned bulk density of 0.563 g/cm³ (see Table 1 below). The conditioned bulk density is usually very close to the bulk density determined in accordance with DIN EN ISO 60 are comparable.

The BET specific surface area of the powder obtained from the precipitation with acetophenone was determined in accordance with DIN EN ISO 9277. A value of 1.12 m²/g was obtained.

The absence of a crystallization peak and a melting peak in the second heating cycle (see FIGS. 1 and 2, middle and lower curves) shows that the originally crystalline material solidified completely or at least substantially amorphously.

TABLE 1
Melting temperature, specific melting enthalpy, particle size distribution,
conditioned bulk density, unconfined yield strength and flow factor
of the powdered material in accordance with the invention.

| | | | | Particle size | | | | | |
|---|---|---|---|---|---|---|---|---|---|
| | | DSC | | distribution | | | | | |
| | | Tm | ΔHm | D10 | D50 | D90 | CBD | UYS | |
| Test | Solvent | [° C.] | [J/g] | [μm] | [μm] | [μm] | [g/cm³] | [Pa] | ff_{c} |
| V1 | dimethylphthalate | 317.8 | 42.8 | 18.9 | 29.6 | 38.3 | n.a. | 904 | 4.8 |
| V2 | acetophenone | 286.2 | 34.4 | 15.2 | 40.7 | 51.3 | 0.563 | 1094 | 4.0 |

n.a. = not available

### Mechanical Properties of Tensile Test Body:

Tensile test bodies with DIN EN ISO 527-2 type 1BA geometry in the XYZ orientation were constructed on a EOS P810 with a reduced construction space (manufacturer: AMCM GmbH, Starnberg). The default job corresponded to that for the material HT-23 (EOS default job for the material HT-23 from Advanced Laser Materials, TX, USA; ALM_HT23-A_120_003); the layer thickness was 120 μm. The energy input per unit volume of the customized illumination parameter is given in the table below.

As can be seen in FIG. 3, the structural components were placed on the construction area. The structural components produced in accordance with the process of the invention and their arrangement with respect to each other are shown in FIG. 4. The text that can be seen in the graphic is for distinguishing the test bodies later on.

The maximum tensile strength, the Young's modulus as well as the elongation at break were determined in accordance with DIN EN ISO 527-2:2012-06 with type 1BA dogbone geometry. A suitable conditioning state for the determination of tensile strength, Young's modulus and elongation at break was the dry state, wherein the test was carried out a maximum of 3 hours after unpacking the structural components. The preferred climate for determining the mechanical properties which was employed was, in accordance with DIN ISO 291, a temperature of 23±2° C. and a relative humidity of the air of 50±10%. The test speed was 2 mm/min.

The density of the three-dimensional objects which were produced was measured in accordance with Archimedes' principle according to ISO 1183 on scales (Kern, type 770-60) using a YDK01 Sartorius density determination kit.

The powder from Vi could be built at a construction space temperature of 280° C. with an energy input per unit volume of 0.208 J/mm³. In the tensile test, the tensile test pieces resulting from this exhibited a maximum tensile strength of 62.6 MPa with a Young's modulus of 2470 MPa and an elongation at break of 3.4%.

Because of its lower melting point, the powder from V1 was constructed at a construction space temperature of 265° C. and an energy input per unit volume of 0.229 J/mm³; the tensile test pieces resulting from this exhibited a maximum tensile strength of 67.5 MPa with a Young's modulus of 2184 MPa and an elongation at break of 5.4%. The structural component density in both tests was 1.249 g/cm³ (V1) or 1.244 g/cm³ (V2). Because amorphous PEI has a density of 1.27 g/cm³, this value shows that dense structural components were produced with a low porosity of 1.7% or 2%.

In particular, the structural components generated from the powders of V1 and V2 in accordance with the invention had significantly higher tensile strengths compared with structural components produced from PEI such as in WO 2018/197577 A1, test series V26.

TABLE 2
Conditions for the production of tensile test pieces
and measurement of the mechanical properties.

| | Construction | Energy input | | | | Structural |
|---|---|---|---|---|---|---|
| | space | per unit | Tensile | Elongation at | Young's | component |
| | temperature | volume | strength | break | modulus | density |
| Test | [° C.] | J/mm³ | [MPa] | [%] | MPa | [g/cm³] |
| V1 | 280 | 0.208 | 62.6 | 3.4 | 2470 | 1.249 |
| V2 | 265 | 0.229 | 67.5 | 5.4 | 2184 | 1.244 |

It can be seen from Examples V1 and V2 that the partially crystalline PEI powder, with a melting temperature of ca. 318° C. or 286° C. and a melting enthalpy of ca. 43 J/g or 34 J/g has a significantly higher melting temperature with an identical melting enthalpy compared with the examples which are known from the literature (WO 2018/197577 A1, V1-9) and Examples V6 and V7 which are not in accordance with the invention. The powders could therefore be built at process chamber temperatures of 280° C. or 265° C., leading to complete and homogeneous melting of the polymer particles without burning it. The structural components constructed in this manner have a high dimensional tolerance.

### Examples V3 and V4

5 g of polyetherimide (PEI, trade name Ultem CRS5001, Sabic) and in 95 g of moderate solvent (corresponding to a loading of 5% by weight) were placed in an autoclave (laboratory steel autoclave with PTFE inserts, type DAB-3, Berghof, with a 250 mL capacity and pressurized to 200 bar and 250° C., magnetic stirrer with a length of 25 mm and a diameter of 6 mm) and heated, with stirring, (600 rpm stirrer speed) to a temperature of 250° C., whereupon the polymer dissolved in the solvent. The pressure set up here corresponded to the vapour pressure of the solvent. Next, the solution was cooled to 60° C. at a rotational speed of 100 rpm with an average temporal temperature gradient of −2 K/min, whereupon the polymer precipitated out of the solution. The separation of the solvent as well as drying was carried out in analogous manner to that for V1 and V2. In analogous manner to that for V1 and V2, the more viscous PEI variation could also be obtained as a fine crystalline powder by precipitation both from dimethylphthalate (V3) as well as from acetophenone (V4).

With a melting temperature of 282.9° C. and a melting enthalpy of 32.1 J/g (V3, see FIG. 5) or 281.3° C. and 33.9 J/g (V4, see FIG. 6), the two powders had comparable thermal properties to the powder generated in V2. The average grain size (D50) was 50.6 μm (distribution width 0.58) for the powder generated in V3 and 79.4 μm (distribution width 1.35) for the powder generated in V4, which are typical values for a powder which can readily be used in laser sintering (see Table 3, below).

In FIGS. 5 and 6, in analogous manner to that for V1 and V2, there was no melting peak (middle curve in each case) or crystallization peak (lower curve in each case) in the second heating cycle, and so after melting, the material also solidifies completely or at least substantially amorphously.

TABLE 3
Melting temperature, specific melting enthalpy
and particle size distribution of the powdered
material in accordance with the invention.

| | | DSC | | Particle size distribution | | |
|---|---|---|---|---|---|---|
| | | Tm | ΔHm | D10 | D50 | D90 |
| Test | Solvent | [° C.] | [J/g] | [μm] | [μm] | [μm] |
| V3 | dimethylphthalate | 282.9 | 32.1 | 35.9 | 50.6 | 65.4 |
| V4 | acetophenone | 281.3 | 33.9 | 33.1 | 79.4 | 139.9 |

### Example V5

The powder was manufactured in analogous manner to that for Example V1, wherein the temperature gradient on cooling was −0.5 K/min. The material used was PEI with the trade name Ultem CRS5011 from Sabic.

In comparable manner to Example V1, the powder obtained was distinguished by a particularly high melting point of 319.5° C. and a melting enthalpy of 41.5 J/g, determined by DSC measurement (FIG. 7, first heating cycle, upper curve). The absence of a crystallization peak in the cooling cycle (lower curve, FIG. 7) and melting peaks in the second heating cycle (middle curve, FIG. 7) shows that after melting, the material solidifies completely or at least substantially amorphously.

With a mean grain size of 33.2 μm (D50) and a D10 and D90 of 15.3 μm or 37.4 μm respectively, a fine powder with a narrow particle size distribution (distribution width of 0.67) was obtained which was readily suitable for laser sintering and which, despite its fineness, was very pourable, as can be seen by the unconfined yield strength of 845 Pa and the ff_{c} of 5.2 (see Table 4 below), determined by means of the Schulze ring shear cell.

TABLE 4
Melting temperature, specific melting enthalpy, particle size
distribution, unconfined yield strength (UYS) and flow factor
(ff_{c}) of a powder in accordance with the invention.

| | | | | Particle size | | | | |
|---|---|---|---|---|---|---|---|---|
| | | DSC | | distribution | | | | |
| | | Tm | ΔHm | D10 | D50 | D90 | UYS | |
| Test | Solvent | [° C.] | [J/g] | [μm] | [μm] | [μm] | [Pa] | ff_{c} |
| V5 | dimethylphthalate | 319.5 | 41.5 | 15.3 | 33.2 | 37.4 | 845 | 5.2 |

### Comparative Examples V6 and V7 (Not in Accordance with the Invention)

For this powder, polyetherimide (trade name Ultem CRS5011, Sabic) in a granular form was crystallized in dichloromethane (treatment for 24 h in liquid solvent), then dried in a vacuum oven at 120° C. and 150 mbar under a dry flow of nitrogen and then cryogenically milled using a pin mill at −20° C. Finally, the powder was sieved at 150 μm.

For V7, the powder obtained was additionally re-crystallized using dichloromethane and then dried using the same conditions as for the granulate (V6).

The powders generated by these methods also exhibited a particle size distribution which was readily suitable for laser sintering, with a mean particle size D50 of 59.8 μm (V6) or 67.3 μm (V7), which exhibited a discernible melting peak in the DSC measurement in the first heating cycle (upper curve, FIG. 8 for V6 and FIG. 9 for V7), showing that the powder was partially crystalline.

The powder generated in V6 had a melting temperature of 252.9° C. and a specific melting enthalpy of 9.7 J/g; the powder from V7 had a melting temperature of 259.7° C. and a specific melting enthalpy of 29.0 J/g. The melting temperatures in particular were therefore significantly below those for the powder in accordance with the invention.

TABLE 5
Melting temperature, specific melting enthalpy and
particle size distribution for the powder in accordance
with the Comparative Examples V6 and V7.

| | DSC | | Particle size distribution | | |
|---|---|---|---|---|---|
| | Tm | ΔHm | D10 | D50 | D90 |
| Test | [° C.] | [J/g] | [μm] | [μm] | [μm] |
| V6 | 252.9 | 9.7 | 33.2 | 59.8 | 80.3 |
| V7 | 259.7 | 29.0 | 38.5 | 67.3 | 113.3 |

1. A composition comprising:
at least one polymer, wherein the polymer is in the form of polymer particles and wherein the polymer is selected from at least one thermoplastic polymer,
wherein the at least one polymer solidifies from a molten material in at least a substantially amorphous or completely amorphous form and is producible as such,
wherein a melting temperature of the polymer is at least 280° C.,
and/or
in that a specific melting enthalpy of the polymer is at least 28 J/g and/or wherein a specific melting enthalpy of the polymer is up to 150 J/g.

2. A composition of claim 1,
wherein the composition can be obtained by means of precipitation from a first moderate solvent or a mixture of the first and at least one further moderate solvent, and
wherein the first moderate solvent and/or the further moderate solvent is selected from at least one organic moderate solvent.

3. The composition of claim 1, wherein the thermoplastic polymer is selected from at least one polyetherimide, polycarbonate, polyarylethersulphone, polyphenylene oxide, acrylonitrile-butadiene-styrene copolymerisate, acrylonitrile-styrene-acrylate copolymerisate, polyvinylchloride, polyacrylate, polyester, polyamide, polyaryletherketone, polyether, polyurethane, polyimide, polyamideimide, polyolefin, polyarylene sulphide, polysiloxane as well as their copolymers and/or at least one polymer blend based on the polymers and/or copolymers cited above.

4. The composition of claim 1, wherein the thermoplastic polymer comprises at least one partially crystalline polymer and/or at least one partially crystalline copolymer and/or at least one partially crystalline polymer blend.

5. The composition of claim 1, wherein the thermoplastic polymer comprises at least one polyetherimide, and wherein the polyetherimide has repeating units in accordance with 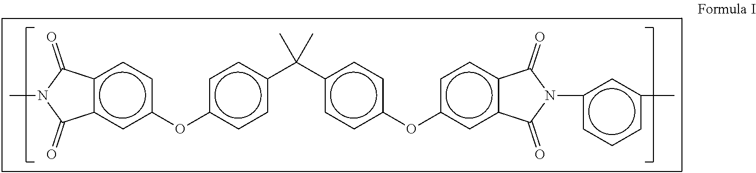
and/or repeating units in accordance with 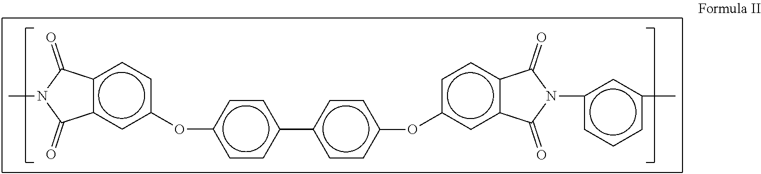
and/or repeating units in accordance with

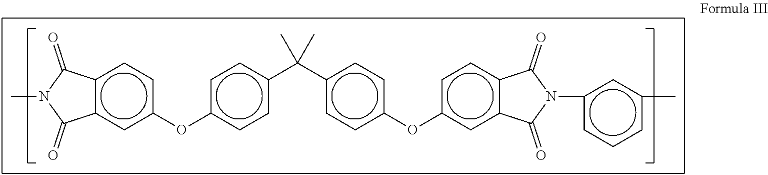

6. The composition of claim 1, wherein the moderate solvent is selected from group formed by an aromatic, non-halogenated homocyclic solvent.

7. The composition of claim 1, wherein a solubility parameter of the medium or solvent is at least at least 5 MPa^{1/2} smaller and/or at most 5 MPa^{1/2} higher than a solubility parameter of the at least one polymer.

8. The composition of claim 1, wherein the at least one medium or solvent is selected from dimethylphthalate and/or acetophenone.

9. A process for the production of a composition of claim 1, wherein the process comprises at least the following steps:
(i) providing at least one polymer material, wherein the polymer material is selected from at least one thermoplastic polymer,
(ii) mixing the polymer material with a solvent at a first temperature, wherein at the first temperature, the medium does not dissolve the at least one polymer and wherein at a second temperature, which is higher than the first temperature, the medium at least partially dissolves the one polymer,
(iii) heating the polymer-solvent mixture at least up to the second temperature, in order to dissolve the polymer in the solvent,
(iv) cooling the polymer-solvent mixture in order to precipitate the polymer out of the solvent, and
(v) obtaining the powdered material.

10. The process for the production of a composition of claim 1, wherein the process additionally comprises at least one of the following steps:
(a) adding at least one first auxiliary substance to the polymer or the polymer-solvent mixture in accordance with step ii) or iii) cited above,
and/or
(b) adding at least one first auxiliary substance or anti-agglomeration agent to the composition or to the powdered material, wherein the addition is carried out after step v) cited above.

11. The process for the production of a composition of claim 9, wherein the polymer-solvent mixture contains at least 10% by weight and/or at most 25% by weight.

12. The process for the production of a composition of claim 9, wherein a moderate solvent is used which is selected from at least one non-halogenated, aromatic moderate solvent,
wherein a solubility parameter of the moderate solvent is at least at least 5 MPa^{1/2} smaller and/or at most 5 MPa^{1/2} higher than a solubility parameter of the at least one polymer,
and/or
wherein the moderate solvent is selected from at least dimethylphthalate and/or acetophenone,
wherein the at least one polymer is selected from at least one polyimide and/or a polyarylethersulphone, from at least one polyetherimide.

13. The process for the production of a composition of claim 9, wherein the cooling of the polymer-solvent mixture from a second temperature to a third temperature is carried out in a manner such that a cooling rate for the polymer-solvent mixture is obtained at a cooling rate of at least 1.5° C./min and/or at most 2° C./min.

14. A process for the production of a three-dimensional object, comprising the steps of:
(i) applying a layer of a composition of claim 1, to a construction area, wherein the composition comprises at least one polymer,
(ii) selectively consolidating the applied layer of the powdered material at positions which correspond to a cross section of the object to be produced by means of an irradiation unit, and
(iii) dropping the carrier down and repeating the steps of application and of consolidation until the three-dimensional object has been completed.

15. (canceled)

16. A three-dimensional object comprising a composition of claim 1.

17. A three-dimensional object comprising a composition of claim 1, wherein the three-dimensional object is in the amorphous or at least substantially amorphous form.

18. Use of a composition of claim 1, which has been produced from the group formed by the powder bed-based processes comprising laser sintering, high speed sintering, binder jetting, multi jet fusion, selective mask sintering, selective laser melting or laser pro fusion.
